(19) United States
(12) Patent Application Publication
(10) Pub. No.: US 2005/0000281 A1
(43) Pub. Date: Jan. 6, 2005

(54) Flow sensor having improved operational performance

(76) Inventors: Uwe Konzelmann, Asperg (DE); Tobias Lang, Stuttgart (DE)

Correspondence Address: KENYON & KENYON, ONE BROADWAY, NEW YORK, NY, 10004, US

(21) Appl. No.: 10/840,034

(22) Filed: May 4, 2004

(30) Foreign Application Priority Data
May 16, 2003 (DE) 10322012.7

(51) Int. Cl. G01F 1/68

(52) U.S. Cl. 73/204.15

(57) ABSTRACT

A flow sensor in which all bridge resistor elements of a bridge circuit are arranged on a chip together with a heating resistor element, so that the drift of the bridge resistor elements will then have only a very slight effect on the output signal of the bridge circuit, which may be picked off at the electrical connections.

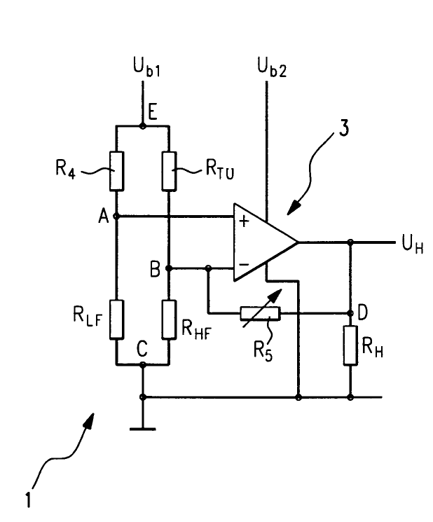

### BACKGROUND INFORMATION

The present invention relates to a so-called hot-film air-mass sensor as it is used to determine the air mass drawn in by an internal combustion engine, for example. In these hot-film air mass sensors, which are called flow sensors in the following, one or a plurality of heating resistor elements is/are heated to a predefined temperature by applying an electrical voltage. As a rule, the temperature of the heating resistor element(s) exceeds the ambient temperature by a fixed amount.

Two temperature sensors are required to control the temperature of the heating resistor element. A first temperature sensor is arranged in the immediate vicinity of the heating resistor element and measures the temperature of the heating resistor element, while a second temperature sensor measures the ambient temperature. Both temperature sensors are usually implemented as resistance-temperature sensors. The temperature difference between the ambient temperature and the heating resistor element may be determined from the different resistances of the first and the second temperature sensor. A bridge circuit is normally used for this purpose. The bridge voltage of this measuring bridge is transmitted, as instantaneous value of the temperature difference between heating resistor element and ambient temperature, to a downstream controller, which may be implemented as a differential amplifier.

Due to environmental influences and the drift of the individual resistor elements, the operational performance of the bridge circuit changes over the course of time, which has a negative effect on the precision of the output signal of the bridge circuit. As a result, the output signals provided by the flow sensor are falsified as well, which the downstream evaluation circuits are unable to detect.

### SUMMARY OF THE INVENTION

In a flow sensor according to the present invention having at least one heating resistor element and a bridge circuit with a plurality of bridge resistor elements, as well as a voltage or current controller, the heating resistor element being arranged on a chip, the present invention provides for the bridge resistors to be arranged on the chip as well.

In this way, all bridge resistors are exposed to the same environmental influences and drifts, which considerably reduces the effects of the resistance drifts on the output signal of the bridge circuit. As a result, the accuracy of the flow sensor according to the present invention is virtually constant over its entire service life.

Variants according to the present invention provide for the bridge circuit to have four bridge resistors, at least one of which is configured as a trimmer resistor.

Moreover, it has shown to be advantageous if the temperature of the heating resistor element is controlled by a differential amplifier, the already mentioned bridge circuit providing the voltage differential to be amplified.

According to the present invention, it is provided in an additional development of the flow sensor that the adjustment of the bridge resistors is implemented via the control of the offset voltage of the differential amplifier.

The flow sensor according to the present invention may advantageously be used to measure the air mass of internal combustion engines.

### BRIEF DESCRIPTION OF THE DRAWING

The FIGURE shows a circuit diagram of a measuring element of a flow sensor according to the present invention on the basis of which the development of the flow sensor according to the present invention is elucidated.

### DETAILED DESCRIPTION

The FIGURE shows the circuit diagram of a flow sensor according to the present invention. The flow sensor is made up of a measuring element having a bridge circuit 1 and a heating resistor element R_{H} as well as a differential amplifier 3. Bridge circuit 1 is made up of four bridge resistor elements R_{LF}, R_{HF}, R_{T0} and R₄. Bridge-resistor element R_{HF} is a resistance temperature sensor, which is arranged on a chip (not shown) in the immediate vicinity of heating resistor element R_{H}. The temperature of heating resistor element R_{H} is determined via the temperature-dependent resistance of bridge resistor element R_{HF}.

Bridge resistor element R_{LF} is likewise a resistance temperature sensor arranged on the chip (not shown) at a distance from heating resistor element R_{H}. Using bridge resistor element R_{LF}, temperature T_{amb} of the ambient air is measured before it reaches heating resistor element R_{H} and is heated by it. The difference in the resistances of bridge resistor elements R_{HF} and R_{LF} thus is a measure of the temperature difference between heating resistor element R_{H} and ambient temperature T_{amb}.

In conventional measuring elements, only heating resistor R_{H} and temperature sensors R_{HF} and R_{LF} are arranged on the chip. The two other bridge resistor elements R_{T0} and R₄ are arranged outside the chip in conventional measuring elements. As a result, resistor elements R_{HF} and R_{LF} and additional bridge resistor elements R_{T0} and R₄ are exposed to different environmental influences, which over the course of time leads to different drifts of the resistor elements. According to the present invention, it is now provided to arrange bridge resistor elements R_{T0} and R₄ on the chip as well, so that all resistor elements of bridge circuit 1 are exposed to the same environmental influences. As a result, there is a considerable reduction in the drift of the output signal of the bridge circuit due to the changes in the Ohmic resistances of bridge resistor elements R_{HF}, R_{LF}, R_{T0} and R₄. This means that the output signal of the measuring element according to the present invention exhibits virtually constant accuracy and quality over the entire service life of the measuring element.

The electrical connections of the chip (not shown) are denoted by the letters A, B, C, D and E in the FIGURE.

The voltage in the diagonal of measuring bridge 1 may be picked off at connections A and B of the not depicted chip. This bridge voltage is transmitted to differential amplifier 3 whose output signal is a heating voltage U_{H}. Output voltage U_{H} is a measure of the air mass flowing across heating resistor element R_{H}. At the same time, the heating line (heating power) of heating resistor element R_{H} is controlled via output voltage U_{H}.

When resistor elements R_{T0} and R₄ are arranged on the chip as well, it suggests itself to etch them out of the same resistor layer as heating resistor element R_{H} and the other bridge resistor elements R_{HF} and R_{LF}. Consequently, resistor elements R_{T0} and R₄ are not adjustable, so that the adaptation of bridge circuit 1 may be implemented by setting an offset voltage at differential amplifier 3. The offset voltage of differential amplifier 3 is set by an adjustable resistor element R₅.

Via electrical connections A to E, the chip (not shown) is electrically connected to an evaluation circuit, in particular differential amplifier 3, and a voltage supply.

If a second control loop (not illustrated) is provided, the direction of the air flow may be detected as well. Such a specific embodiment works according to the so-called twin-heater principle.

1. A flow sensor comprising:
at least one heating resistor element situated on a chip;
a bridge circuit having a plurality of bridge resistor elements, the bridge resistor elements being situated on the chip; and
at least one of a voltage controller and a current controller for controlling a temperature of the heating resistor element.

2. The flow sensor according to claim 1, wherein the bridge circuit has four bridge resistor elements.

3. The flow sensor according to claim 1, wherein at least one of the bridge resistor elements is a trimmer resistor element.

4. The flow sensor according to claim 1, wherein the at least one of the voltage controller and current controller includes a differential amplifier.

5. The flow sensor according to claim 4, wherein an adjustment of the bridge resistor elements is implemented via an offset voltage of the differential amplifier.

6. The flow sensor according to claim 1, further comprising first and second control loops, a flow direction of a medium to be measured being detected by comparing output variables of the first and second control loops.

7. The flow sensor according to claim 1, wherein the flow sensor is used to measure an air mass drawn in by an internal combustion engine.
